(19) United States
(12) Patent Application Publication
(10) Pub. No.: US 2008/0095359 A1
(43) Pub. Date: Apr. 24, 2008

(54) Security System for Wireless Networks

(75) Inventors: Oliver Schreyer, Herzogenrath (DE); Bozena Erdmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,009

(22) PCT Filed: Jul. 11, 2005
(86) PCT No.: PCT/IB05/52290

§ 371 Date: Jan. 12, 2007

(30) Foreign Application Priority Data
Jul. 15, 2004 (EP) 04103385.3

(51) Int. Cl. H04L 9/00

(52) U.S. Cl. 380/44

(57) ABSTRACT

The invention relates to a device (21) for managing guest key records (6) in wireless home networks (1), comprising at least one interface (211) for connecting a guest key transmitter (GKT) (5), a key generator (212) and a transmission unit (213) for transmitting a generated key record (6) to the GKT (5). The invention also relates to a security system for wireless networks, comprising a portable guest unit (5) for short-range transmission of a guest key record (GKT), at least one device (21) according to the invention and at least one receiving unit (31) for receiving the key record (6) in at least one wireless home apparatus (3) and/or access point (2) of the network (1). The invention further relates to a method of dynamic key management in wireless home networks (1), wherein at least one key record (6) is generated by a device (21) according to the invention; the key record (6) is subsequently transmitted to a GKT (5) via an interface (213); the key record (6) or a part of the key record (6) is transmitted from the GKT (5) to the guest apparatus (4) by way of short-range transmission; based on the key record (6), an encrypted connection is established between the guest apparatus (4) and the home network (1); at least one guest configuration is installed on at least one home apparatus (3) and/or access point (2) of the network (1), and the guest configuration is removed after terminating the guest apparatus (4) access by reconfiguring at least one home apparatus (3) and/or access point (2).

The invention relates to a security system for wireless networks. The invention also relates to a device and a method for managing guest key records in wireless home networks.

In the future, consumer electronics apparatuses will be interconnected via digital home networks. The wireless transmission technology has made great progress and will eventually lead to a large number of wireless home networks. Initially, the user of a home network will have a closed network which provides the required services (including Internet access), protected from any external access. This is a technical challenge, particularly for wireless home networks. It is to be ensured that the wireless transmission is protected from unauthorized access or interception.

Users of such home networks will require functionalities for providing guest access in a controlled way. The guest will often bring his own apparatus and may want to connect it to the home network. The following problems are then to be solved. The connection between the guest apparatus and the home network is to be established in a simple and secure way. The access time as well as the guest access rights should be controllable. Furthermore, the network security in the case of guest access should have the same level as in the case of a closed network. It is particularly necessary to protect the wireless networks from unauthorized or inadvertent interception of the transmitted information, as well as from unauthorized access to the network and hence to its resources. Moreover, an unambiguous identification of the network should be possible for an apparatus which wants to be associated with a given network within a plurality of networks in the radio transmission range.

WO 2004/014040 A1 discloses a security system providing network identification and encryption of data exchange between a guest apparatus and an apparatus of the network in a user-friendly way. To this end, a key record is stored on a portable unit. This record comprises a secret key code as an essential constituent. The key record is transmitted to a receiving unit of the guest apparatus via a transmission unit by way of short-range transmission of information. The key record is thus supplied free from interception to any wireless apparatus in the network.

A key generator generating a so-called guest key record is provided especially for guest apparatuses. The guest key record is used to guarantee guest access to resources of the network. To this end, a guest key record by means of which the guest apparatuses (e.g. laptop) can communicate with the relevant apparatuses in the home network is supplied to all apparatuses of the home network (i.e. to the apparatuses allowed for use in connection with the guest apparatuses) and to the guest apparatuses (which do not belong to the home network).

To prevent unauthorized use of a guest key record by a previous guest, the key generator automatically generates a new guest key record in accordance with the random principle after a fixed period of time (e.g. 60 minutes) after the last guest key record transmission. A new guest thus receives a guest key record which is different from the previous one so that it is ensured that the previous guest cannot utilize the presence of the new guest for unauthorized access to the home network.

The above-mentioned known security system uses two key records, namely, one home key record (stored on a short-key transmitter SKT) and a guest key record (stored on a guest-key transmitter GKT). Both SKT and GKT are transportable units, essentially comprising a memory for storing a key record as well as a transmitting and receiving unit for transmitting and receiving a key record. While the home key record will be valid for a very long period of time (possibly throughout the lifetime of the home network), the guest key record should only be valid for the time of a guest's visit and should consequently be changed after every visit. To this end, it is necessary to remove the guest configuration after the visit from the home network apparatuses (hereinafter referred to as home apparatuses). To this end, the above-mentioned document proposes automatic erasure of the guest key record in the home apparatuses after a fixed period of time, or erasure by way of user interaction. Alternatively, a user interaction may be performed to erase a guest key record, for example, by once more introducing the current home key record, pressing a special key on the home apparatuses concerned or on one of these home apparatuses which subsequently informs all the other relevant home apparatuses automatically.

It is an object of the invention to provide a device for managing guest key records, which renders it possible to dynamically modify a guest key record and is also suitable for removing the guest configuration after termination of access to any one guest apparatus from this apparatus as well as from other relevant apparatuses in the network.

The object is solved by a device comprising at least one interface for connecting a guest-key transmitter (GKT), a key generator and a transmission unit for transmitting a generated key record to the GKT.

The invention provides a device for managing guest key records in wireless home networks, by which the envisaged object is achieved.

In a further embodiment of the invention, the device comprises a detection unit detecting the connection to and disconnection of a GKT from the interface. This provides the possibility of automatically generating a new guest key record after connecting a GKT with a subsequent transmission to the GKT without requiring any further user interaction. The detection of disconnecting the GKT from the interface may also be utilized to install the guest configuration on the home apparatus.

Advantageously, the detection unit is formed in such a way that, after detection of the connection of the GKT to the interface, the generation of a new key record by the key generator as well as the transmission of the new key record to the GKT is triggered. This counteracts abuse of a key record after terminating access by a guest apparatus.

In a further embodiment, the interface comprises holding elements for fixing a GKT, for example, a mechanical or a magnetic holding element. By fixing the GKT to the interface, data transmission errors due to failing contacts are avoided.

The device comprises a further interface via which it is connectable to a home apparatus. Signalization of other apparatuses of the network on whether the GKT is connected to the device is provided by this connection. This signal can be used to trigger the removal of the guest configuration from a home apparatus.

In an advantageous embodiment, the device can be integrated in the home apparatus. The common use of the processor unit of the home apparatus is possible in this case.

The home apparatus is preferably a radio base station (access point). When more than one home apparatus is to be reconfigured, the access point may transmit corresponding reconfiguration messages to the home apparatuses via standard protocols.

The object is further solved by a security system for wireless networks, comprising:

a portable guest unit for short-range transmission of a guest key record (GKT),

at least one of the above-mentioned embodiments of the device according to the invention, and

at least one receiving unit for receiving the key record in at least one wireless home apparatus and/or access point of the network.

At least one wireless apparatus of the network comprises a module for installing and/or removing guest configurations. The initial configuration of an apparatus (configuration prior to installing a guest apparatus by means of GKT) can thus be established. The module may be stored on the apparatus by means of, for example, a software procedure. Alternatively, it may be connected by means of permanent wiring.

The module is preferably formed in such a way that the removal of a guest configuration is triggered whenever the GKT is connected to the device according to the invention. This provides the possibility of a result-oriented reconfiguration of the home apparatus after termination of the guest access.

The object is also solved by a method, wherein

at least one key record is generated by an embodiment of the device according to the invention, as described hereinbefore,

the key record is subsequently transmitted to a GKT via an interface,

the key record or a part of the key record is transmitted from the GKT to the guest apparatus by way of short-range transmission,

based on the key record, an encrypted connection is established between the guest apparatus and the home network and at least one guest configuration is installed on at least one home apparatus and/or access point of the network, and

the guest configuration is removed after terminating the guest apparatus access by reconfiguring at least one home apparatus and/or access point.

The installation of the guest configuration on the home apparatus and/or access point is triggered by removing the GKT to the device. This enhances the user friendliness of the method. The reconfiguration of the home apparatus and/or the access point is preferably triggered by connecting the GKT to the device.

In a further embodiment of the invention, the home apparatus is reconfigured by a short-key transmitter (SKT). This ensures a transmission of the reconfiguration data free from interception.

In a further embodiment, the reconfiguration of the home apparatus is triggered by activating a switch provided on this apparatus. The data required for reconfiguration are permanently present in the memory of the home network.

In a further embodiment, the reconfiguration of the home apparatus is triggered by distributing the required configuration information from an access point with the integrated device. Alternatively, the required reconfiguration data may be stored in the home apparatus.

Further embodiments are defined in the remaining dependent claims.

These and other aspects of the invention are apparent from and will be elucidated with reference to the embodiments described hereinafter.

In the drawing:

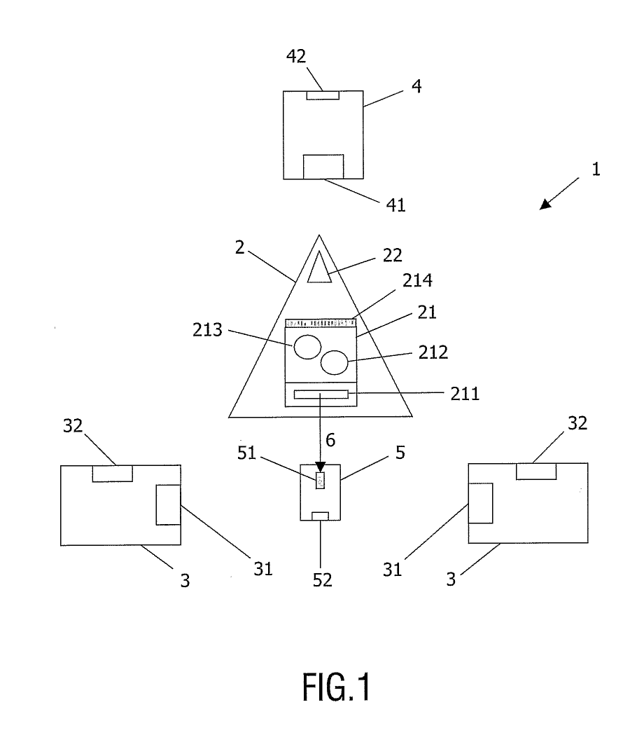

FIG. 1 shows diagrammatically a security system.

In this embodiment, the security system according to the invention comprises a wireless home network 1 consisting of an access point 2 and two home apparatuses 3.

The access point 2 corresponds to the IEEE 802.11 standard and has a corresponding radio interface 22. A device for guest key management in the form of a “GKT holder” 21 is integrated in the access point 2 and data-technically connected via an internal interface 214. The GKT holder 21 comprises an interface 211 for connecting a GKT 5. In this embodiment, the interface 211 is formed as a card slot and the GKT 5 is formed as a corresponding card on which an RF tag 51 is arranged. The GKT holder 21 comprises a processing unit 212 and a tag writer 213. The processing unit 212 comprises, inter alia, a key generator. Instead of using the independent processing unit 212, it is also possible to use the processing unit of the access point 2 (shared processing). Alternatively, the GKT 5 may be designed as a two-way infrared system in which the GKT holder 21 has a corresponding infrared lens. The home apparatuses 3 as well as the guest apparatus 4 comprise a receiving unit 31, 41 for short-range transmission of a key record 6 transmitted by a GKT 5. Furthermore, the apparatuses 3, 4 comprise a radio interface 32, 42, operating in accordance with the IEEE 802.11 standard, for transmitting useful data streams within the home network.

The GKT 5 is inserted into the slot 211 of the GKT holder 21. The processing unit 212 of the access point 2 generates a random key record 6 which is written on the RF tag 51 of the GKT 5 via the tag writer 213 of the GKT holder 21. When a guest apparatus 4 wants to be connected to the home network 1, the guest apparatus 4 is configured by means of the key record 6 transmitted from the transmission unit 52 of the GKT 5 to the receiving units 31, 41 in such a way that it is connected to the network 1.

After ending the access by the guest apparatus 4, the GKT 5 is re-inserted into the GKT holder 21 so that the RF tag 51 of the GKT 5 is rewritten via the tag writer 213 with a new key record 6 generated by the processing unit 212. Simultaneously, the detection unit (not shown) of the GKT holder 21 detects the insertion of the GKT 5 in the slot 211 and passes on this information via the interface 214 to the access point 2 which reconfigures itself and, if necessary, signalizes to the home apparatuses 3 that a reconfiguration is to be performed so that the guest settings on these apparatuses are removed. It may be sufficient to only reconfigure the access point 2 (for example, an access point in accordance with the IEEE 802.11i standard). Alternatively, the reconfiguration of the apparatuses 3 can be triggered by removing the GKT 5 from the GKT holder 21. The original data required for the reconfiguration are either permanently stored in the home apparatuses 3 or are determined, via short-range transmission, by means of an SKT (not shown) in which these data are permanently stored.

When a plurality of home apparatuses 3 is to be configured for connection of a guest apparatus 4, the key record 6 may be distributed on the home apparatuses 3 via the access point 2. For reconfiguring the apparatuses, the original configuration data may be transmitted accordingly to the home apparatuses 3 via the access point 2. In this embodiment, the reconfiguration is performed by means of corresponding procedures used for the home apparatuses 3. When the GKT 5 is re-inserted into the slot 211, the reconfiguration of all home apparatuses 3 can be triggered automatically in this way so that the network 1 is closed.

As long as the GKT 5 is connected to the GKT holder 21, which is integrated in the access point 2, the home network is situated in its “home configuration”. When the GKT 5 is removed from the GKT holder 21, the access point 2 internally changes to the guest configuration. The key record 6 is transmitted to the guest apparatus 4 which thus gains access to the home network. When the access by the guest apparatus 4 has ended, the GKT 5 is re-inserted into the GKT holder 21, which is detected by the access point 2. The access point changes back to the home configuration (the network 1 is closed) and the GKT holder 21 writes a new (random) key record 6 on the GKT 5.

1. A device (21) for managing guest key records (6) in wireless home networks (1), comprising at least one interface (211) for connecting a guest key transmitter (GKT) (5), a key generator (212) and a transmission unit (213) for transmitting a generated key record (6) to the GKT (5).

2. A device as claimed in claim 1, characterized in that the device (21) comprises a detection unit detecting the connection to and disconnection of a GKT (5) from the interface (211).

3. A device as claimed in claim 1, characterized in that the detection unit is formed in such a way that, after detection of the connection of the GKT (5) to the interface (211), the generation of a new key record (6) by the key generator (212) as well as the transmission of the new key record (6) to the GKT (5) is triggered.

4. A device as claimed in claim 1, characterized in that the interface (211) comprises holding elements for fixing a GKT (5).

5. A device as claimed in claim 1, characterized in that the device (21) comprises a further interface (214) via which it is connectable to an apparatus (2, 3) of the network (1).

6. A device as claimed in claim 1, characterized in that it can be integrated in an apparatus (2, 3) of the network (1).

7. A device as claimed in claim 5, characterized in that the apparatus (2) is an access point.

8. A security system for wireless networks, comprising a portable guest unit (5) for short-range transmission of a guest key record (GKT), at least one device (21) as claimed in claim 1 and at least one receiving unit (31) for receiving the key record (6) in at least one wireless home apparatus (3) and/or access point (2) of the network (1).

9. A security system as claimed in claim 8, characterized in that at least one wireless apparatus (3) and/or access point (2) of the network (1) comprises a module for installing and/or removing guest configurations.

10. A security system as claimed in claim 9, characterized in that the module is formed in such a way that the removal of the guest configuration is triggered whenever a GKT (5) is connected to the device (21).

11. A method of dynamic key management in wireless home networks (1), wherein:
at least one key record (6) is generated by a device (21) as claimed in claim 1,
the key record (6) is subsequently transmitted to a GKT (5) via an interface (213),
the key record (6) or a part of the key record (6) is transmitted from the GKT (5) to the guest apparatus (4) by way of short-range transmission,
based on the key record (6), an encrypted connection is established between the guest apparatus (4) and the home network (1) and at least one guest configuration is installed on at least one home apparatus (3) and/or access point (2) of the network (1), and
the guest configuration is removed after terminating the guest apparatus (4) access by reconfiguring at least one home apparatus (3) and/or access point (2).

12. A method as claimed in claim 11, characterized in that the installation of the guest configuration on the home apparatus (3) and/or access point (2) is triggered by removing the GKT (5) from the device (21).

13. A method as claimed in claim 11, characterized in that the reconfiguration of the home apparatus (3) and/or access point (2) is triggered by connecting the GKT (5) to the device (21).

14. A method as claimed in claim 11, characterized in that the home apparatus (3) is reconfigured by a short-key transmitter (SKT).

15. A method as claimed in claim 11, characterized in that the reconfiguration of the home apparatus (3) is triggered by activating a switch provided on said apparatus.

16. A method as claimed in claim 11, characterized in that the reconfiguration of the home apparatus (3) is triggered by distributing the required configuration information from an access point (2) with the integrated device (21).
